(19) United States
(12) Patent Application Publication
(10) Pub. No.: US 2025/0379222 A1
(43) Pub. Date: Dec. 11, 2025

(54) HYDROGEN STORAGE ALLOY AND ALKALINE STORAGE BATTERY

(71) Applicant: Panasonic Intellectual Property Management Co., Ltd., Osaka (JP)

(72) Inventors: HUNGTSUNG YI, Osaka (JP); AKIKO OKABE, Osaka (JP)

(21) Appl. No.: 18/995,191

(22) PCT Filed: May 29, 2023
(86) PCT No.: PCT/JP2023/019839

§ 371 Date: Jan. 16, 2025

(30) Foreign Application Priority Data
Jul. 29, 2022 (JP) 2022-121447

(51) Int. Cl. H01M 4/38; H01M 10/30

(52) U.S. Cl. CPC H01M 4/385; H01M 10/30

(57) ABSTRACT

A disclosed hydrogen-absorbing alloy has a composition represented by a formula LaₐR_{(b-a)}Mg_{c}Zr_{d}NiₓAl_{y}M_{z}, wherein R is at least one rare earth element including Y but not including La, 0.10≤a≤0.40, 0.67≤b≤0.96, 0.01≤c≤0.30, 0.01≤d≤0.05, and b+c+d=1.00 are satisfied, M is at least one element selected from the group consisting of Co, Mn, Ag, and Sn, 3.10≤x≤3.80, 0.03 ≤y≤0.25, 0≤z≤0.05, and 3.45≤x+y+z≤3.85 are satisfied, and the alloy includes, as crystal phases, four phases respectively having a Ce₂Ni₇ type structure, a Ce₅Co₁₉ type structure, a Pr₅Co₁₉ type structure, and a CaCu₅ type structure, at specific proportions.

### TECHNICAL FIELD

The present disclosure relates to a hydrogen-absorbing alloy and an alkaline storage battery.

### BACKGROUND ART

Alkaline storage batteries such as nickel-metal hydride storage batteries are used in various applications. Conventionally, various proposals have been made on hydrogen-absorbing alloys used for nickel-metal hydride storage batteries.

PTL 1 (Japanese Patent Publication No. 5171114) discloses “a hydrogen-absorbing alloy for an alkaline storage battery used as a negative electrode active material of the alkaline storage battery, the hydrogen-absorbing alloy containing an element R selected from a rare earth element excluding La and including Y and Group 4, and an element M including at least one of Co, Mn and Zn, wherein the hydrogen-absorbing alloy is represented by a general formula La_{α}R_{1-α-β}Mg_{β}Ni_{γ-η-ε}Al₇₃ M_{ε}, wherein 0≤α≤0.5, 0.1≤β≤0.2, 3.7≤γ≤3.9, 0.1≤Θ≤0.3, and 0≤ε≤0.2 are satisfied, an A₅B₁₉ type structure is more than or equal to 40% in a crystal structure, the A₅B₁₉ type structure is formed of a Ce₅Co₁₉ crystal phase and a Pr₅Co₁₉ crystal phase and includes the Ce₅Co₁₉ crystal phase as a main component”.

PTL 2 (Japanese Patent Application Laid-Open Publication No. 2008-084649) discloses “a hydrogen-absorbing alloy for an alkaline storage battery used as a negative electrode active material of an alkaline storage battery, the hydrogen-absorbing alloy including a mixed phase including at least a Ce₂Ni₇ type structure and a Ce₅Co₁₉ type structure”.

PTL 3 (Japanese Patent Publication No. 5512080) discloses “an alkaline storage battery including a positive electrode, a negative electrode containing a rare earth-Mg—Ni-based hydrogen-absorbing alloy, a separator, and an electrolytic solution,
wherein a main crystal structure of the rare earth-Mg—Ni-based hydrogen-absorbing alloy is a Ce₂Ni₇-type structure or the similar structure thereto, and
the rare earth-Mg—Ni-based hydrogen-absorbing alloy has a composition represented by a general formula:

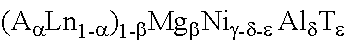

where A represents one or more elements including at least Sm selected from the group consisting of Pr, Nd, Sm, and Gd, Ln represents at least one element selected from the group consisting of La, Ce, Pm, Eu, Tb, Dy, Ho, Er, Tm, Yb, Lu, Sr, Sc, Y, Ti, Zr, and Hf, T represents at least one element selected from the group consisting of V, Nb, Ta, Cr, Mo, Mn, Fe, Co, Zn, Ga, Sn, In, Cu, Si, P, and B, subscripts α, β, γ, δ, and ε represent numbers satisfying 0.4≤α, 0.05<β<0.15, 3.0≤γ≤4.2, 0.15≤δ≤0.30, and 0≤ε≤0.20, respectively, a Sm amount in A is more than or equal to 35% with respect to a total amount of A)”.

PTL 4 (Japanese Patent Publication No. 6061354) discloses “a hydrogen-absorbing alloy in which two or more crystal phases having crystal structures different from each other are stacked in a c-axis direction of the crystal structures, the hydrogen-absorbing alloy containing a crystal phase having a Ce₅Co₁₉ type crystal structure (hereinafter, the phase is referred to as “Ce₅Co₁₉ phase”), wherein a total content of the Ce₅Co₁₉ phase, a Pr₅Co₁₉ phase, a Ce₂Ni₇ phase, and a CaCu₅ phase is more than or equal to 70 mass %, and the CaCu₅ phase is less than or equal to 30 mass % (including a case where the content of the crystal phases other than the Ce₅Co₁₉ phase is 0), and the hydrogen-absorbing alloy has a composition represented by LaₕR6ᵢR7ⱼMgₖR8′ₘ₁R8″ₘ₂, where R6 is one or two or more elements selected from the group consisting of rare earth elements including Y and excluding La, R7 is one or two or more elements selected from the group consisting of Zr, Ti, Zn, Sn and V, R8′ is one or two elements selected from Ni and Co, and R8″ is one or two elements selected from Mn and A1, and 11≤h≤16, 0≤i≤6, 0≤j≤0.65, 2≤k≤5.5, 0.70≤h/(h+i)≤0.85, 72≤m1≤77, 3≤m2≤6 (Mn content is less than or equal to 3 mol %), m1+m2=m, h+i+j+k+m=100 are satisfied) “.

### CITATION LIST

### Patent Literature

PTL 1: Japanese Patent Publication No. 5171114
PTL 2: Japanese Patent Application Laid-Open Publication No. 2008-084649
PTL 3: Japanese Patent Publication No. 5512080
PTL 4: Japanese Patent Publication No. 6061354

### SUMMARY OF THE INVENTION

Conventionally, to improve various characteristics, alloy compositions and crystal phase proportions have been studied a lot, but the limit is to improve discharge characteristics at −10° C., and it has not been possible to improve the discharge characteristics at a cryogenic temperature less than −10° C., for example, at −30° C. In particular, both high-rate discharge characteristics at −30° C. and the charge-discharge cycle characteristics at room temperature have not been improved at all.

Since alkaline storage batteries are used in various situations, various characteristics are required. For example, in applications of in-vehicle equipment such as a vehicle emergency call system, in recent years, a battery having good characteristics of high-rate discharge at a cryogenic temperature (for example, 2 It (A) discharge at −30° C.) has been required. Further, a battery having good charge-discharge cycle characteristics in addition to cryogenic-temperature high-rate discharge characteristics is required.

One aspect of the present disclosure relates to a hydrogen-absorbing alloy. The hydrogen-absorbing alloy has a composition represented by Formula (F) shown below:

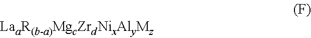

wherein R is at least one rare earth element including Y but not including La, 0.10≤a≤0.40, 0.67≤b≤0.96, 0.01≤c≤0.30, 0.01≤d≤0.05, and b+c+d=1.00 are satisfied,
M is at least one element selected from the group consisting of Co, Mn, Ag, and Sn,
3.10≤x≤3.80, 0.03≤y≤0.25, 0≤z≤0.05, and 3.45≤x+y+z≤3.85 are satisfied,
the hydrogen-absorbing alloy comprising, as crystal phases:
   a first phase that is one phase selected from the phase group consisting of a phase having a Ce₂Ni₇ type structure, a phase having a Ce₅Co₁₉ type structure, and a phase having a Pr₅Co₁₉ type structure;
   a second phase that is another phase selected from the phase group;
   a third phase that is still another phase selected from the phase group; and
   a fourth phase having a CaCu₅ type structure, and
in the crystal phases, 67 <α, γ≤β≤α, 60≤α+β≤83, α/β≤15.0, and 1≤δ≤15 are satisfied, where a (mass %) is a constituent proportion of the first phase, β (mass %) is a constituent proportion of the second phase, γ (mass %) is a constituent proportion of the third phase, and δ (mass %) is a constituent proportion of the fourth phase.

Another aspect of the present disclosure relates to an alkaline storage battery. The alkaline storage battery is an alkaline storage battery including a positive electrode, a negative electrode containing a negative electrode active material, and an alkaline electrolytic solution, wherein the negative electrode active material contains the hydrogen-absorbing alloy according to one aspect of the present disclosure.

As long as a combination is possible, matters recited in two or more claims freely selected from a plurality of claims recited in the appended claims may be combined. The configurations described in the exemplary embodiment may be freely combined, as long as the combination is possible.

In the present disclosure, provided is an alkaline storage battery having good cryogenic-temperature high-rate discharge characteristics and charge-discharge cycle characteristics at normal temperature. Also provided is a hydrogen-absorbing alloy used for the alkaline storage battery.

### BRIEF DESCRIPTION OF THE DRAWINGS

FIG. 1 is a partially exploded perspective view schematically illustrating an alkaline storage battery according to a first exemplary embodiment.

FIG. 2 is a diagram showing results of evaluation on the alkaline storage battery according to the first exemplary embodiment.

FIG. 3 is a diagram showing the results of evaluation on the alkaline storage battery according to the first exemplary embodiment.

FIG. 4 is a diagram showing the results of evaluation on the alkaline storage battery according to the first exemplary embodiment.

FIG. 5 is a diagram showing the results of evaluation on the alkaline storage battery according to the first exemplary embodiment.

FIG. 6 is a diagram showing the results of evaluation on the alkaline storage battery according to the first exemplary embodiment.

FIG. 7 is a diagram showing the results of evaluation on the alkaline storage battery according to the first exemplary embodiment.

FIG. 8 is a diagram showing the results of evaluation on the alkaline storage battery according to the first exemplary embodiment.

FIG. 9 is a diagram showing the results of evaluation on the alkaline storage battery according to the first exemplary embodiment.

FIG. 10 is a diagram showing the results of evaluation on the alkaline storage battery according to the first exemplary embodiment.

FIG. 11 is a diagram showing the results of evaluation on the alkaline storage battery according to the first exemplary embodiment.

FIG. 12 is a diagram showing the results of evaluation on the alkaline storage battery according to the first exemplary embodiment.

### DESCRIPTION OF EMBODIMENT

Hereinafter, the exemplary embodiment according to the present disclosure will be described with reference to examples, but the present disclosure is not limited to the examples which will be described below. In the following description, specific numerical values and materials are disclosed as examples in some cases, but other numerical values and materials may be applied, as long as the invention according to the present disclosure can be implemented. In this specification, the description “numerical value A to numerical value B” includes a numerical value A and a numerical value B, and can be read as “from numerical value A to numerical value B inclusive”. In the following description, when a plurality of lower limits and a plurality of upper limits of numerical values relating to specific physical properties, conditions, and the like are exemplified, any of the plurality of exemplified lower limits and any of the plurality of exemplified upper limits may be freely selected and combined, as long as the lower limit is not more than or equal to the upper limit.

As described above, currently, an alkaline storage battery having good cryogenic- temperature high-rate discharge characteristics and charge-discharge cycle characteristics is required. As a result of studies, the present inventors have newly found that an alkaline storage battery having good cryogenic-temperature high-rate discharge characteristics and charge-discharge cycle characteristics can be obtained by using a hydrogen-absorbing alloy having a specific composition and a specific crystal structure. The present disclosure is based on the new finding. The present disclosure provides a hydrogen-absorbing alloy having a composition and constituent proportions of crystal phases capable of improving both of the above two types of characteristics.

### Hydrogen-Absorbing Alloy

Hereinafter, the hydrogen-absorbing alloy according to the present exemplary embodiment may be referred to as “hydrogen-absorbing alloy (M)”. Hydrogen-absorbing alloy (M) has the following composition (I) and crystal phase (II).

### (I) Composition

The composition of hydrogen-absorbing alloy (M) is represented by Formula (F) shown below.

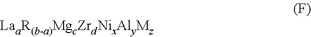

wherein R is at least one rare earth element including Y but not including La, 0.10≤a≤0.40, 0.67≤b≤0.96, 0.01≤c≤0.30, 0.01≤d≤0.05, and b+c+d=1.00 are satisfied, M is at least one element selected from the group consisting of Co, Mn, Ag, and Sn, and 3.10≤x≤3.80, 0.03≤y≤0.25, 0≤z≤0.05, and 3.45≤x+y+z≤3.85 are satisfied.

Element R may be composed only of one element or may be composed of a plurality of rare earth elements. For example, element R may be at least one element selected from the group consisting of Sm, Y, Pr, and Nd. Element R may be any one element of Sm, Y, Pr, and Nd, or may be a plurality of elements among these elements.

Element M may be any one element of Co, Mn, Ag, and Sn, or may be a plurality of elements among these elements.

Examples of hydrogen-absorbing alloy (M) include a hydrogen-absorbing alloy shown as an example of hydrogen-absorbing alloy (M) in Examples which will be described later (for example, powder a1 of the hydrogen-absorbing alloy used for the negative electrode of battery A1 and powder a1′ to be powder a1 through activation).

The powders (powders a1 and a1′) of the hydrogen-absorbing alloy have a composition formula La_{0.35}Sm_{0.47}Mg_{0.15}Zr_{0.03}Ni_{3.36}Al_{0.09}, and the proportions of the crystal phases are 38 mass % for the Ce₅Co₁₉ type crystal, 37 mass % for the Ce₂Ni₇ type crystal phase, 19 mass % for the Pr₅Co₁₉ type crystal phase, and 6 mass % for the CaCu₅ type crystal phase. The combination of the composition and the proportions of the crystal phases can be achieved for the first time by including Zr as an essential element, setting the composition ratio of La and Mg within the above range, and setting heat treatment conditions of an ingot at the time of alloy production to be predetermined conditions (for example, 960° C., 10 hours). The same applies to other hydrogen-absorbing alloys (M) other than powders a1′ and a1. These findings are novel findings that have not conventionally been provided.

By using hydrogen-absorbing alloy (M) such as powder a1, the effect that could not conventionally be achieved has been achieved, that is, the effect of improving both the high-rate discharge characteristics at a cryogenic temperature of −30° C. and the charge-discharge cycle life characteristics at normal temperature has been achieved. The configuration and effect of powder a1 of the hydrogen-absorbing alloy are a finding and an effect that have not been found conventionally, and they were found for the first time by the present inventors. The hydrogen-absorbing alloy (for example, powder a1) shown in Examples is an example of hydrogen-absorbing alloy (M), and various combinations and patterns of the composition and the proportions of the crystal phases are possible. Examples thereof include those disclosed in this specification, such as the examples described below.

In Formula (F), 0.01≤c<0.10 (for example, 0.02≤c≤0.09) may be satisfied. When this formula is satisfied, the charge-discharge cycle characteristics of the alkaline storage battery can be particularly improved.

In Formula (F), 0.20<c≤0.30 (for example, 0.21≤c≤0.30 or 0.21≤c≤0.28) may be satisfied. When this formula is satisfied, the high-rate discharge characteristics of the alkaline storage battery at a cryogenic temperature can be particularly enhanced.

In Formula (F), condition (1) shown below may be satisfied, condition (2) or (2′) may be satisfied, and condition (3) or (3′) may be satisfied.
(1) Element R contains Sm or is Sm.
(2) z=0 is satisfied.
(2′) 0<z≤0.05 (for example, 0.01≤z≤0.05) is satisfied.
(3) 0.01≤c<0.10 (for example, 0.02≤c≤0.09) is satisfied.
(3′) 0.10≤c≤0.30 (for example, 0.2021 c≤0.30, or 0.21≤c≤0.28) is satisfied.

In Formula (F), the above conditions may be satisfied in any of the following patterns.
Pattern a: Conditions (1), (2), and (3) are satisfied.
Pattern b: Conditions (1), (2′), and (3) are satisfied.
Pattern c: Conditions (1), (2′), and (3′) are satisfied.
Pattern d: Conditions (1), (2), and (3′) are satisfied.

In Formula (F), x may be more than or equal to 3.30 or more than or equal 3.40, and may be less than or equal to 3.70 or less than or equal to 3.50. In Formula (F), y may be more than or equal to 0.09, and may be less than or equal to 0.19.

The composition of hydrogen-absorbing alloy (M) can be changed by changing the mixing proportions of the materials. For example, the composition of hydrogen-absorbing alloy (M) can be changed by changing the mixing proportions of the materials when an ingot of the alloy is produced.

The composition of hydrogen-absorbing alloy (M) can be determined by an ICP emission spectrometry method. The ICP emission spectrometry can be performed using an inductively coupled plasma (ICP) emission spectrometer specified in JIS K0116. Specifically, first, an alloy sample is pretreated using an acid (nitric acid, hydrochloric acid, or the like) to obtain a sample solution. Next, the obtained sample solution is sprayed into a plasma torch of the spectrometer, and light emission of a specific element is measured. From the wavelength and intensity of the light emission, the type of the element contained in the sample and the amount of the element can be specified.

(II) Crystal phase

Hydrogen-absorbing alloy (M) includes, as crystal phases, first, second, and third phases (crystal phases) selected from the phase group consisting of a phase having a Ce₂Ni₇ type structure, a phase having a Ce₅Co₁₉ type structure, and a phase having a Pr₅Co₁₉ type structure, respectively, and a fourth phase (crystal phase) having a CaCu₅ type structure.

In the crystal phases of hydrogen-absorbing alloy (M), δ<α, γ≤β≤α, 60≤α+β≤83, α/β≤15.0, and 1≤δ≤15 are satisfied, where a (mass %) is a constituent proportion of the first phase, β (mass %) is a constituent proportion of the second phase, γ (mass %) is a constituent proportion of the third phase, and δ (mass %) is a constituent proportion of the fourth phase.

In this specification, the phase having the CaCu₅ type structure may be referred to as “CaCu₅ type crystal phase”, and the phase having the Ce₂Ni₇ type structure, the phase having the Ce₅Co₁₉ type structure, and the phase having the Pr₅Co₁₉ type structure may be referred to as “Ce₂Ni₇ type crystal phase”, “Ce₅Co₁₉ type crystal phase”, and “Pr₅Co₁₉ type crystal phase”, respectively. In the present specification, unless otherwise specified, the constituent proportion of a crystal phase means a constituent proportion expressed in mass %.

The first phase is a phase having the highest constituent proportion among the Ce₂Ni₇ type crystal phase, the Ce₅Co₁₉ type crystal phase, and the Pr₅Co₁₉ type crystal phase. The second phase is a phase having the same constituent proportion as that of the first phase or lower than that of the first phase among the three phases. The third phase is a phase having the same constituent proportion as that of the second phase or lower than that of the second phase among the three phases. The crystal phase of hydrogen-absorbing alloy (M) is usually composed of the first to third phases and the CaCu₅ type crystal phase. The crystal phase of hydrogen-absorbing alloy (M) may contain a crystal phase (fifth phase) other than these four phases. However, in the crystal phases, the constituent proportion of the fifth phase is usually lower than the constituent proportion of the third phase.

Regarding the constituent proportions α, β, and γ, γ<β≤α may be satisfied, γ≤β<α may be satisfied, or γ<β<α may be satisfied. α may be more than or equal to 29, more than or equal to 38, or more than or equal to 50, and may be less than or equal to 77, less than or equal to 65, less than or equal to 55, or less than or equal to 48. β may be more than or equal to 5, more than or equal to 9, or more than or equal to 20, and may be less than or equal to 37, less than or equal to 27, or less than or equal to 20. γ may be more than or equal to 4, more than or equal to 11, or more than or equal to 17, and may be less than or equal to 28, less than or equal to 19, or less than or equal to 17. 8 may be more than or equal to 1, more than or equal to 4, or more than or equal to 9, and may be less than or equal to 15, less than or equal to 12, or less than or equal to 8.

α/β may be more than or equal to 1.0, more than or equal to 4.1, or more than or equal to 7.8, and may be less than or equal to 15.0, less than or equal to 10.7, or less than or equal to 7.8.

The constituent proportions α, β, γ, and δ may satisfy the following patterns.

Pattern A: α is in the range from 70 to 75, β is in the range from 6 to 9, γ0 is in the range from 3 to 8, and δ is in the range from 11 to 15.

Pattern B: α is in the range from 60 to 66, β is in the range from 14 to 20, γ is in the range from 8 to 12, and δ is in the range from 8 to 13.

Pattern C: α is in the range from 50 to 60, β is in the range from 17 to 28, γ is in the range from 6 to 20, and δ is in the range from 1 to 13.

Pattern D: α is in the range from 33 to 48, β is in the range from 27 to 37, γ is in the range from 13 to 26, and δ is in the range from 6 to 14.

The crystal structures of the first phase, the second phase, and the third phase may be any of the following patterns. For example, when γ<⊖<α is satisfied, the crystal structures of the first phase, the second phase, and the third phase may be any of the following patterns.
Pattern 1: The first phase is the Ce₅Co₁₉ type crystal phase, the second phase is the Ce₂Ni₇ type crystal phase, and the third phase is the Pr₅Co₁₉ type crystal phase.
Pattern 2: The first phase is the Ce₅Co₁₉ type crystal phase, the second phase is the Pr₅Co₁₉ type crystal phase, and the third phase is the Ce₂Ni₇ type crystal phase.
Pattern 3: The first phase is the Ce₂Ni₇ type crystal phase, the second phase is the Ce₅Co₁₉ type crystal phase, and the third phase is the Pr₅Co₁₉ type crystal phase.
Pattern 4: The first phase is the Ce₂Ni₇ type crystal phase, the second phase is the Pr₅Co₁₉ type crystal phase, and the third phase is the Ce₅Co₁₉ type crystal phase.
Pattern 5: The first phase is the Pr₅Co₁₉ type crystal phase, the second phase is the Ce₅Co₁₉ type crystal phase, and the third phase is the Ce₂Ni₇ type crystal phase.
Pattern 6: The first phase is the Pr₅Co₁₉ type crystal phase, the second phase is the Ce₂Ni₇ type crystal phase, and the third phase is the Ce₅Co₁₉ type crystal phase.

When any one of the patterns a to d is satisfied, any one of the patterns A to D may be further satisfied. In any of those combination patterns, any of the patterns 1 to 6 may be satisfied.

The constituent proportion of each crystal phase can be changed by changing the composition of hydrogen-absorbing alloy (M) and/or the production conditions of hydrogen-absorbing alloy (M). For example, the constituent proportions of the crystal phases can be changed by changing the conditions of the heat treatment of on the ingot of the alloy. When the temperature of the heat treatment was lowered, an A₂B₇ type crystal phase (Ce₂Ni₇ type crystal phase) tended to be easily formed. When the temperature of the heat treatment was increased, an A₅B₁₉ type crystal phase (Ce₅Co₁₉ type crystal phase, Pr₅Co₁₉ type crystal phase) tended to be easily formed. When the time of the heat treatment was reduced, the Ce₅Co₁₉ type crystal phase of the A₅B₁₉ type crystal phase tended to be easily formed. When the time of the heat treatment was increased, the Pr₅Co₁₉ type crystal phase of the A₅B₁₉ type crystal phase tended to be easily formed.

The constituent proportions of the crystal phases constituting hydrogen-absorbing alloy (M) are specified by performing X-ray diffraction measurement on pulverized alloy powder and analyzing the obtained X-ray diffraction pattern using a Rietveld method. Specific conditions will be described in Examples.

The mass saturation magnetization of hydrogen-absorbing alloy (M) may be in the range from 1.0 emu/g to 4.0 emu/g. By setting the mass saturation magnetization within this range, an alkaline storage battery having particularly high cryogenic-temperature high-rate discharge characteristics and charge-discharge cycle characteristics can be obtained. The mass saturation magnetization may be in the range from 1.0 emu/g to 2.0 emu/g or may be in the range from 2.0 emu/g to 4.0 emu/g. By setting the mass saturation magnetization to be less than or equal to 4.0 emu/g, the charge-discharge cycle characteristics of the alkaline storage battery can be improved. By setting the mass saturation magnetization to be more than or equal to 1.0 emu/g, the cryogenic-temperature high-rate discharge characteristics of the alkaline storage battery can be improved.

The mass saturation magnetization of hydrogen-absorbing alloy (M) changes depending on an amount of nickel clusters on the surface of the hydrogen-absorbing alloy. The nickel cluster on the surface of an alloy particle can be increased by a step of stirring the alloy in an aqueous alkali solution. In addition, the mass saturation magnetization can be increased by performing initial activation of the battery.

The mass saturation magnetization was measured using a vibrating sample magnetometer (VSM) (small fully automatic vibrating sample magnetometer VSM-C7-10A manufactured by Toei Industry Co., Ltd.). Specifically, the value of the mass saturation magnetization is a value measured by filling 0.2 g of a hydrogen-absorbing alloy powder in a sample holder of the magnetometer and applying a magnetic field of 10 kOe.

Hydrogen-absorbing alloy (M) is used as a negative electrode active material in a state of powder (particles). The average particle size of hydrogen-absorbing alloy (M) may be in the range from 15 μm to 30 μm. By setting the average particle size within this range, an alkaline storage battery having particularly high cryogenic-temperature high-rate discharge characteristics and charge-discharge cycle characteristics can be obtained. By setting the average particle size to less than or equal to 30 μm, the cryogenic-temperature high-rate discharge characteristics of the alkaline storage battery can be improved. By setting the average particle size to be more than or equal to 15 μm, the charge-discharge cycle characteristics of the alkaline storage battery can be improved. In this specification, the average particle size is a median size (D50) at which a cumulative volume is 50% in a volume-based particle size distribution. The median size is determined using a laser diffraction/scattering type particle size distribution measuring apparatus. The average particle size of hydrogen-absorbing alloy (M) can be adjusted by changing the grinding conditions of the alloy.

### Example of Method for Producing Hydrogen-Absorbing Alloy (M))

An example of a method for producing hydrogen-absorbing alloy (M) will be described below. Hydrogen-absorbing alloy (M) may be produced by a method other than the method described below.

The production method of the present example includes step (i) of producing an ingot of an alloy represented by Formula (F) and step (ii) of performing a heat treatment on the ingot. The production method may further include, after step (ii), step (iii) of grinding the ingot to obtain an alloy powder (alloy particles). The production method may further include, after step (iii), step (iv) of activating the alloy powder. The production method may further include a step of washing the alloy or the alloy powder after any of the above steps. Each step will be described below.

### Step (i)

Step (i) is a step of alloying the metals to constitute an alloy to produce an ingot of the alloy having a composition represented by Formula (F). As the metals to be the materials, single metals may be used, or an alloy may be used. The method for alloying is not limited, and a known alloying method may be used. As an alloying method, a plasma arc melting method, a high frequency melting method, a rapid cooling solidification method, or the like may be used. These methods may be used singly, or a plurality of methods may be combined. For example, the rapid cooling solidification method and the high frequency melting method may be combined.

In step (i), a mixture of alloy materials (single metal of each constituent element) is alloyed by the above-described method or the like. For example, the mixture may be melted by heating the mixture to alloy the constituent elements. When the alloy materials are mixed in step (i), the mixing ratio of each metal is adjusted so that hydrogen-absorbing alloy (M) has a desired composition. An alloy of the constituent elements may be used as a part of the materials of the alloy.

The alloy in a melted state obtained by melting the mixture of the materials is solidified, whereby an ingot is obtained. The solidification of the alloy can be performed by cooling the alloy in a melted state. For example, the solidification of the alloy may be performed by supplying the alloy in a melted state to a container such as a mold and cooling the alloy in the container. From the viewpoint of enhancing dispersibility of the constituent elements in the alloy, a supply rate of the alloy in the melted state and the like may be appropriately adjusted. In addition, the cooling rate of the alloy in the melted state may be appropriately adjusted.

### Step (ii)

Step (ii) is a step of performing a heat treatment on the ingot obtained in step (i). Through this heat treatment, the constituent proportions of the crystal phases can be changed. In addition, through the heat treatment, the dispersibility of the constituent elements in the hydrogen-absorbing alloy is easily adjusted, and the hydrogen-absorbing alloy is easily activated. The heat treatment may be performed, for example, in an atmosphere of an inert gas (for example, argon gas) at a temperature in the range from 800° C. to 1100° C. for a time in the range from 7 hours to 13 hours. One preferred example of the heat treatment is performed under an atmosphere of inert gas (for example, argon gas) at a temperature in the range from 900° C. to 980° C. (for example, in the range from 900° C. to 960° C.) for a time in the range from 9 hours to 12 hours. According to the present condition, the above-described constituent proportions of the crystal phases is easily realized. The temperature of the heat treatment may be in the range from 900° C. to 980° C., in the range from 910° C. to 980° C., in the range from 920° C. to 980° C., in the range from 940° C. to 980° C., in the range from 950° C. to 980° C., or in the range from 960° C. to 980° C. In any of these ranges, the upper limit may be 980° C., 960° C., or 950° C. unless the lower limit is more than or equal to the upper limit. The time for the heat treatment performed in these temperature ranges may be in the range from 7 hours to 13 hours (for example, 9 hours to 12 hours). In this manner, an ingot of hydrogen-absorbing alloy (M) can be obtained.

Step (iii)

Step (iii) is a step of pulverizing the alloy (ingot) subjected to step (ii) to obtain an alloy powder (alloy particles). The method for pulverizing the alloy is not limited, and a known pulverization method may be used. The alloy can be pulverized by wet pulverization, dry pulverization, or the like, and these may be combined. The pulverization may be performed using a ball mill or the like. In the wet pulverization, a liquid medium (water or the like) is used at the time of pulverization. The obtained particles may be classified as necessary. The average particle size of the alloy particles can be changed by changing the conditions of pulverization. In this manner, a powder of hydrogen-absorbing alloy (M) can be obtained. This powder may be further activated and then used as the negative electrode active material.

### Step (iv)

Step (iv) is a step of activating the alloy powder (alloy particles) obtained in step (iii). The activation can be performed by bringing the alloy powder into contact with an aqueous alkali solution. The method for bringing the alloy powder into contact with an aqueous alkali solution is not particularly limited. For example, the alloy powder may be immersed in an aqueous alkali solution, or the alloy powder may be added to an aqueous alkali solution and stirred. The activation may be performed under heating as necessary. The activation may be performed using an acidic aqueous solution instead of an aqueous alkali solution. The activation may be performed using an acidic aqueous solution after using an aqueous alkali solution.

As the aqueous alkali solution, for example, an aqueous solution containing an alkali metal hydroxide (potassium hydroxide, sodium hydroxide, lithium hydroxide, or the like) or the like as an alkali can be used. As the alkali metal hydroxide, sodium hydroxide and/or potassium hydroxide is preferably used. From the viewpoint of activation efficiency and the like, the concentration of the alkali in the aqueous alkali solution may be in the range from 5 mass % to 50 mass % (for example, in the range from 10 mass % to 45 mass %).

The alloy powder after the activation treatment with an aqueous alkali solution may be washed with water. The alloy powder after the activation treatment is usually dehydrated. To reduce the impurities remaining on the surface of the alloy powder, it is preferable to perform water washing until the pH of the water used for washing becomes less than or equal to 9. The alloy powder after activation (or after activation and washing) can also be used as the powder of hydrogen-absorbing alloy (M).

In this manner, a powder of hydrogen-absorbing alloy (M) can be obtained. The obtained alloy powder can be used as a negative electrode active material of a nickel-metal hydride storage battery. As described later, by using hydrogen-absorbing alloy (M) as a negative electrode active material, an alkaline storage battery (nickel-metal hydride storage battery) having good cryogenic-temperature high-rate discharge characteristics and charge-discharge cycle characteristics can be obtained.

### Alkaline Storage Battery

Hereinafter, the alkaline storage battery according to the present exemplary embodiment may be referred to as “alkaline storage battery (A)”. Alkaline storage battery (A) includes a positive electrode, a negative electrode containing a negative electrode active material, and an alkaline electrolytic solution. The negative electrode active material contains hydrogen-absorbing alloy (M) described above. Since hydrogen-absorbing alloy (M) has been described above, redundant description will be omitted.

Alkaline storage battery (A) is, for example, a nickel-metal hydride storage battery containing nickel hydroxide as a positive electrode active material. Thus, in the present specification, alkaline storage battery (A) can be replaced with a “nickel-metal hydride storage battery (A)”. As shown in Examples, alkaline storage battery (A) has good cryogenic-temperature high-rate discharge characteristics and good charge-discharge cycle characteristics. Such alkaline storage battery (A) is preferably used for applications in which high-rate discharge is performed at a cryogenic temperature. For example, alkaline storage battery (A) is preferably used as an in-vehicle battery.

In alkaline storage battery (A), potassium hydroxide (KOH) is preferably dissolved in the alkaline electrolytic solution. Since potassium hydroxide is dissolved, an aqueous solution having high conductivity can be obtained. The potassium concentration (more specifically, the concentration of potassium ions) of the alkaline electrolytic solution may be in the range from 5.5 mol/L to 8.0 mol/L. By setting the concentration within this range, the cryogenic-temperature high-rate discharge characteristics and the charge-discharge cycle characteristics can be particularly enhanced. When the potassium concentration of the alkaline electrolytic solution is less than or equal to 8.0 mol/L, charge-discharge cycle characteristics can be improved. By setting the potassium concentration to be more than or equal to 5.5 mol/L, the cryogenic-temperature high-rate discharge characteristics can be improved.

### Method for Producing Alkaline Storage Battery (A)

The method for producing alkaline storage battery (A) is not particularly limited except that hydrogen-absorbing alloy (M) is used, and a known production method may be used. In one example of the production method, first, an electrode group is formed by using a positive electrode, a negative electrode, and a separator. Next, the electrode group and an electrolytic solution are housed in an exterior body. In this manner, an alkaline storage battery can be produced.

Examples of the configuration and constituent elements of alkaline storage battery (A) will be described below. However, the configuration and constituent elements of alkaline storage battery (A) are not limited to the following examples. Known constituent elements used in alkaline storage batteries (for example, nickel-metal hydride storage batteries) may be applied as the constituent elements other than hydrogen-absorbing alloy (M).

An example of alkaline storage battery (A) includes an exterior body, and an electrode group and an alkaline electrolytic solution housed in the exterior body. The form of the electrode group is not limited, and it may be a wound body or a form other than the wound body (for example, a stack). The electrode group in the form of a wound body is formed by winding the positive electrode, the negative electrode, and the separator such that the separator is disposed between the positive electrode and the negative electrode. The electrode group in the form of a stack is formed by stacking the positive electrode, the negative electrode, and the separator such that the separator is disposed between the positive electrode and the negative electrode. The shape of alkaline storage battery (A) is not limited, and may be a cylindrical shape, an angular shape, a button shape (including a coin shape), or the like.

### Positive Electrode

The positive electrode is not particularly limited, and a positive electrode used in a known nickel-metal hydride storage battery may be used. The positive electrode contains a positive electrode mixture containing a positive electrode active material. The positive electrode may include a positive electrode current collector and a positive electrode mixture (positive electrode mixture layer) supported by a positive electrode current collector. The positive electrode may be a paste-type positive electrode.

The positive electrode current collector is not particularly limited, and a known positive electrode current collector may be used. Examples of the positive electrode current collector include a porous current collector formed of metal (nickel, nickel alloy, or the like). Specifically, examples of the positive electrode current collector include a nickel foam and a sintered nickel plate.

The positive electrode mixture contains particles of a nickel compound (positive electrode active material), and may contain other components (conductive material, binder, thickener, and the like) as necessary. As the particles of the nickel compound, particles of a known nickel compound (for example, nickel hydroxide) used in an alkaline storage battery may be used. A part of nickel hydroxide in the positive electrode mixture may be changed to nickel oxyhydroxide.

The particles of the nickel compound may contain trace components other than nickel hydroxide and nickel oxyhydroxide. The surface of the particles of the nickel compound may be covered with another compound. Examples of the compound used for such covering include metal hydroxides and the like. Specifically, examples of the compound used for covering include cobalt hydroxide, γ-cobalt oxyhydroxide, and β-cobalt oxyhydroxide.

The conductive material is not particularly limited, and a known conductive material may be used. Examples of the conductive material include conductive fibers such as metal fibers; and metal particles such as nickel powder and cobalt powder. These conductive materials may be used singly or in combination of two or more thereof. As the conductive material, a conductive cobalt compound (cobalt hydroxide, cobalt oxyhydroxide of γ type, or the like) may be used.

The amount of the conductive material may be in the range from 0.01 parts by mass to 20 parts by mass (for example, the range from 0.1 parts by mass to 10 parts by mass) with respect to 100 parts by mass of the active material.

The conductive material may be added to the positive electrode paste, mixed with other components, and used. The surface of the active material particles may be coated with a conductive material in advance. The coating method using the conductive material is not limited, and a known method may be used. For example, the coating may be performed by applying the conductive material to the surface of the active material particle. Alternatively, the coating may be performed by attaching a dispersion containing the conductive material to the surface of the active material particles and drying the dispersion. Alternatively, the coating may be performed by a mechanochemical method or the like.

The binder is not particularly limited, and a known binder used for an alkaline storage battery may be used. Examples of the binder include a rubber material such as styrene-butadiene copolymer rubber; polyolefin resin such as polyethylene and polypropylene; fluorine resin such as polyvinylidene fluoride; acrylic resins such as ethylene-acrylic acid copolymers and ethylene-methyl acrylate copolymers, and Na ion-crosslinked products thereof. These binders can be used singly or in combination of two or more thereof. The amount of the binder may be less than or equal to 7 parts by mass or may be in the range from 0.01 parts by mass to 5 parts by mass with respect to 100 parts by mass of the positive electrode active material.

Examples of the thickener include carboxymethylcellulose and modified products thereof (including salts such as Na salts, ammonium salts, and the like), cellulose derivatives such as methylcellulose; saponified polymers having vinyl acetate units such as polyvinyl alcohol; and polyalkylene oxides such as polyethylene oxide. These thickeners may be used singly or in combination of two or more thereof. The amount of the thickener may be less than or equal to 5 parts by mass or may be in the range from 0.01 parts by mass to 3 parts by mass with respect to 100 parts by mass of the positive electrode active material.

The positive electrode can be formed by attaching a positive electrode mixture containing a positive electrode active material to a positive electrode current collector. In the production of the positive electrode, the positive electrode mixture is usually used in the form of a paste containing a dispersion medium. In an example of the method for producing the positive electrode, first, a positive electrode paste containing a positive electrode active material is prepared. Next, the positive electrode paste is applied to or filled in the positive electrode current collector, and then dried and rolled. In this manner, a positive electrode including a positive electrode current collector and a positive electrode mixture layer supported by the positive electrode current collector can be produced.

### Negative Electrode

The negative electrode is not particularly limited except that the negative electrode contains hydrogen-absorbing alloy (M) as the negative electrode active material. As the constituent element other than the negative electrode active material, a constituent element of a negative electrode used in a known nickel-metal hydride storage battery may be used. In one aspect, the present disclosure provides a negative electrode containing hydrogen-absorbing alloy (M) as a negative electrode active material. The negative electrode is used as a negative electrode of an alkaline storage battery (specifically, a nickel-metal hydride storage battery).

The negative electrode may include a negative electrode current collector and a negative electrode mixture layer which is supported by the negative electrode current collector. The negative electrode current collector is not limited, and a known negative electrode current collector may be used. Examples of the negative electrode current collector include a porous or nonporous sheet of metal (stainless steel, nickel, nickel alloy, or the like).

The negative electrode can be formed by attaching a negative electrode mixture containing a negative electrode active material to a negative electrode current collector. In the production of the negative electrode, the negative electrode mixture is usually used in the form of a paste containing a dispersion medium. In an example of the method for producing the negative electrode, first, a negative electrode paste containing a powder of hydrogen-absorbing alloy (M) is prepared. Next, the negative electrode paste is applied to or filled in the negative electrode current collector, and then dried and rolled. In this manner, a negative electrode including a negative electrode current collector and a negative electrode mixture layer which is supported by the negative electrode current collector can be produced.

The negative electrode mixture may contain components other than the negative electrode active material (conductive agent, binder, thickener, and the like) as necessary. As the dispersion medium, the conductive material, the binder, and the thickener, the same dispersion mediums, conductive materials, binders, and thickeners as those exemplified for the positive electrode may be used. The amounts of the conductive material, the binder, and the thickener with respect to 100 parts by mass of the negative electrode active material may be in the ranges exemplified as the amounts with respect to 100 parts by mass of the positive electrode active material.

### Alkaline Electrolytic Solution

As the alkaline electrolytic solution, an aqueous solution containing an alkaline solute can be used. Examples of the solute include alkali metal hydroxides, and specifically include lithium hydroxide, potassium hydroxide, and sodium hydroxide. The solute may be used singly or in combination of two or more thereof.

The concentration of the solute (specifically, an alkali metal hydroxide) contained in the alkaline electrolytic solution may be in the range from 2.5 mol/L to 13 mol/L (for example, 3 mol/L to 12 mol/L). The specific gravity of the alkaline electrolytic solution may be in the range from 1.1 to 1.6 (for example, in the range from 1.2 to 1.5).

As described above, the alkaline electrolytic solution preferably contains potassium hydroxide. The alkaline electrolytic solution may contain potassium hydroxide and other alkali metal hydroxides (lithium hydroxide and/or sodium hydroxide). The alkaline electrolytic solution may contain only potassium hydroxide as the solute, or may contain potassium hydroxide and sodium hydroxide.

### Separator

The separator is not particularly limited, and a known separator used for an alkaline storage battery (for example, a nickel-metal hydride storage battery) may be used. Examples of the form of the separator include a microporous membrane, a nonwoven fabric, and a woven fabric. The separator can be formed of an insulating material. Examples of the material of the separator include a polyolefin resin such as polyethylene or polypropylene; a fluorine resin; and a polyamide resin.

### Others

The constituent elements (exterior body, lead, and the like) other than those described above are not particularly limited, and known ones used for alkaline storage batteries (for example, nickel-metal hydride storage batteries) may be used. When alkaline storage battery (A) is a cylindrical battery, an exterior body as an example includes a bottomed cylindrical battery case, and a sealing body and a gasket that seal the battery case.

Hereinafter, an example of the present exemplary embodiment will be specifically described with reference to the drawings. The above-described constituent elements can be applied to the constituent elements of the exemplary embodiment as an example described below. The constituent elements of the exemplary embodiment as an example described below can be changed based on the above description. The matters described below may be applied to the exemplary embodiment described above. In the exemplary embodiment as an example described below, constituent elements that are not essential to the alkaline storage battery according to the present disclosure may be omitted.

### First Exemplary Embodiment

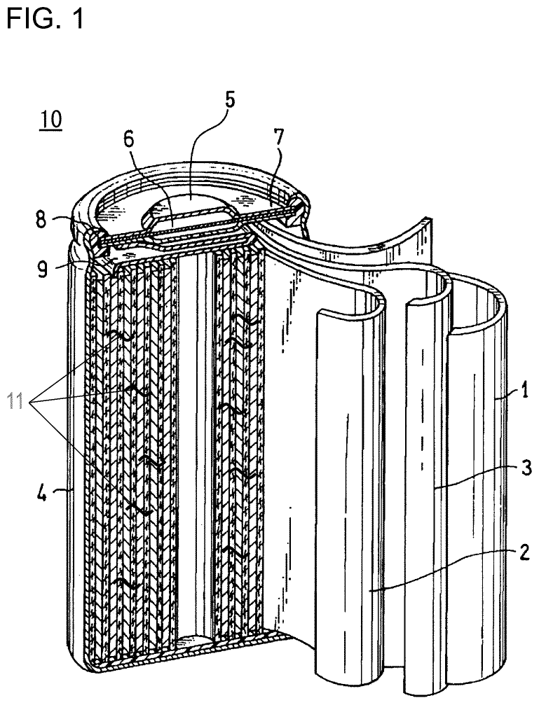

Alkaline storage battery 10 of a first exemplary embodiment is illustrated in FIG. 1. Alkaline storage battery 10 is a nickel-metal hydride storage battery.

FIG. 1 is a partially exploded perspective view schematically illustrating a structure of alkaline storage battery 10. Alkaline storage battery 10 includes battery case 4, and an electrode group and alkaline electrolytic solution 11 housed in battery case 4. Battery case 4 is a bottomed cylindrical case. The electrode group is formed by winding negative electrode 1, positive electrode 2, and separator 3 such that separator 3 is disposed between negative electrode 1 and positive electrode 2. An opening of battery case 4 is sealed by sealing body 7 and insulating gasket 8. Sealing body 7 includes positive electrode terminal 5 and safety valve 6. Positive electrode 2 and sealing body 7 are electrically connected via positive electrode current collection plate 9. Battery case 4 is electrically connected to negative electrode 1 and functions as a negative electrode terminal.

Negative electrode 1 includes a negative electrode current collector and a negative electrode mixture layer which is disposed on the negative electrode current collector. The negative electrode mixture layer contains a powder of hydrogen-absorbing alloy (M) as a negative electrode active material.

### Appendix

The following technologies are disclosed by the above description of the exemplary embodiment.

### (Technology 1)

A hydrogen-absorbing alloy having a composition represented by Formula (F) shown below:

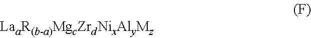

wherein R is at least one rare earth element including Y but not including La, 0.10≤a≤0.40,
0.67≤b≤0.96, 0.01≤c≤0.30, 0.01≤d≤0.05, and b+c+d=1.00 are satisfied,
M is at least one element selected from the group consisting of Co, Mn, Ag, and Sn, and
3.10≤x≤3.80, 0.03≤y≤0.25, 0≤z≤0.05, and 3.45≤x+y+z≤3.85 are satisfied,
the hydrogen-absorbing alloy comprises, as crystal phases:
   a first phase that is one phase selected from the phase group consisting of a phase having a Ce₂Ni₇ type structure, a phase having a Ce₅Co₁₉ type structure, and a phase having a Pr₅Co₁₉ type structure;
   a second phase that is another phase selected from the phase group;
   a third phase that is still another phase selected from the phase group; and
   a fourth phase having a CaCu₅ type structure, and
in the crystal phases, δ<α, γ≤β≤α, 60≤α+β≤83, α/β≤15.0, and 1≤δ≤15 are satisfied, where a (mass %) is a constituent proportion of the first phase, β (mass %) is a constituent proportion of the second phase, γ (mass %) is a constituent proportion of the third phase, and δ (mass %) is a constituent proportion of the fourth phase.

### Technology 2

The hydrogen-absorbing alloy according to Technology 1, wherein 0.01≤c<0.10 is satisfied in Formula (F).

### Technology 3

The hydrogen-absorbing alloy according to Technology 1, wherein 0.20<c≤0.30 is satisfied in Formula (F).

### Technology 4

The hydrogen-absorbing alloy according to any one of Technologies 1 to 3, the hydrogen-absorbing alloy having an average particle size in a range from 15 μm to 30 μm.

### Technology 5

An alkaline storage battery including a positive electrode, a negative electrode containing a negative electrode active material, and an alkaline electrolytic solution,
wherein the negative electrode active material contains the hydrogen-absorbing alloy according to any one of Technologies 1 to 4.

### Technology 6

The alkaline storage battery according to Technology 5,
wherein potassium hydroxide is dissolved in the alkaline electrolytic solution, and
the alkaline electrolyte solution has a potassium concentration in a range from 5.5 mol/L to 8.0 mol/L.

### Technology 7

The alkaline storage battery according to Technology 5 or 6, wherein the hydrogen-absorbing alloy has a mass saturation magnetization in a range from 1.0 emu/g to 4.0 emu/g.

### EXAMPLES

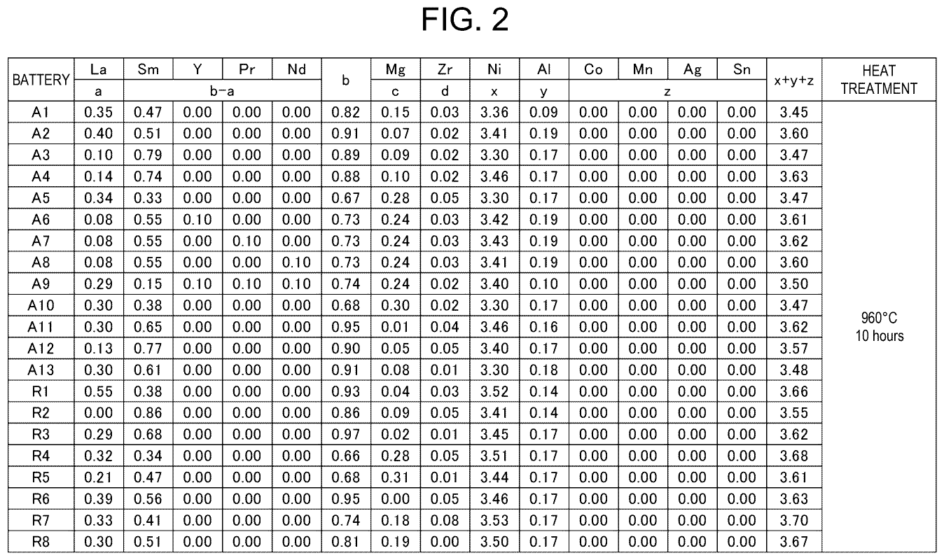

Hereinafter, the present disclosure will be described in more detail by way of Examples. In the following Examples, a plurality of nickel-metal hydride storage batteries were produced and evaluated. FIGS. 2 to 12 are diagrams illustrating the results of evaluation on the storage batteries according to the first exemplary embodiment.

### Experimental Example 1

In Experimental Example 1, a plurality of types of nickel-metal hydride storage batteries were produced by changing the hydrogen-absorbing alloy (negative electrode active material). Specifically, a nickel-metal hydride storage battery (battery A1) having a structure similar to the structure illustrated in FIG. 1 was produced by the following procedure.

### Production of Battery A1

### (1) Production of Hydrogen-Absorbing Alloy

A hydrogen-absorbing alloy used as a negative electrode active material of battery A1 was produced by the following procedure.

### (1-a) Production of Alloy Ingot

An ingot of the hydrogen-absorbing alloy was obtained by mixing metals (simple substances of La, Sm, Mg, Zr, Ni, and Al) as raw materials of the alloy so that a to d and x to z in Formula (F) had values shown in FIG. 2 to obtain a mixture, melting the mixture in a high frequency melting furnace, and then cooling the mixture.

### (1-b) Heat Treatment and Grinding of Ingot

The obtained ingot was subjected to a heat treatment at 960° C. for 10 hours under an argon atmosphere. The ingot after the heat treatment was pulverized into coarse particles. The obtained coarse particles were pulverized in the presence of water using a wet ball mill to obtain a powder in a wet state. The powder was sieved with a sieve having a mesh diameter of 75 μm. In this manner, a hydrogen-absorbing alloy powder (powder a1′) having an average particle size of 21.2 μm was obtained.

### (1-c) Composition Analysis of Hydrogen-Absorbing Alloy and Structure Analysis of Crystal Phase

The composition of powder a1′ and the structure analysis of the crystal phases were performed by the following method. The composition of the hydrogen-absorbing alloy was obtained by ICP emission spectrometry as described above. The constituent proportions of the crystal phases of the hydrogen-absorbing alloy was obtained by performing X-ray diffraction measurement and analyzing the obtained X-ray diffraction pattern using a Rietveld method. Specifically, the obtained hydrogen-absorbing alloy was pulverized in a mortar, and then the pulverized alloy was measured using a powder X-ray diffractometer (D8Advance manufactured by Bruker AXS Inc.). The measurement conditions were: divergence slit 0.5 deg., scattering slit None, light receiving slit 0.1 mm, X-ray source Cu—Kα ray, tube voltage 40 kV, and tube current 40 mA. The diffraction angle was in the range of 2θ=10.0° to 90.0°, the counting time was 3 seconds, and the scanning step was 0.020°. Based on the obtained results of X-ray diffraction, structural analysis was performed by a Rietveld method (High Score Plus Ver. 4.8 manufactured by PANalytical). Through the structural analysis, the constituent proportions of the crystal phases constituting the hydrogen-absorbing alloy were obtained.

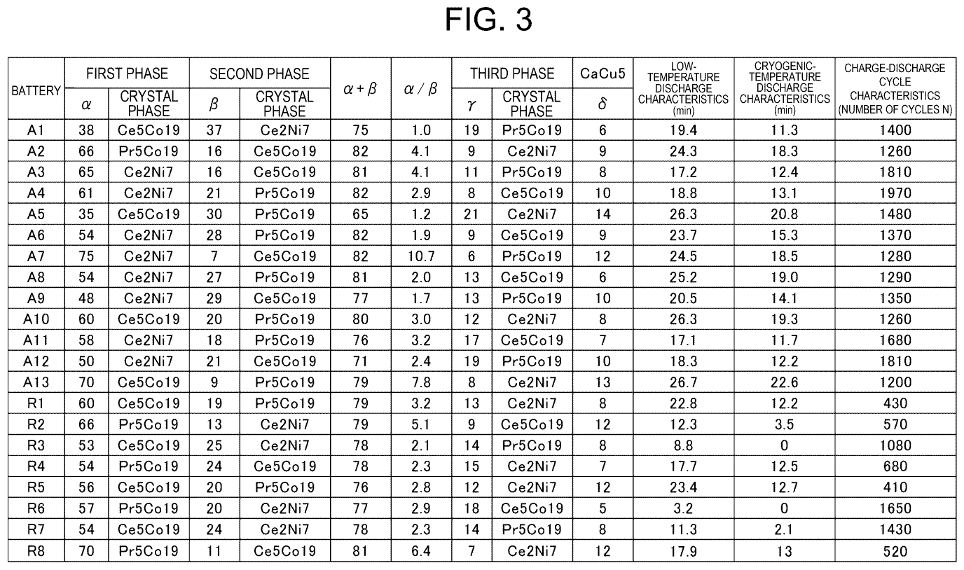

The composition of the powder of the hydrogen-absorbing alloy obtained by the above steps is represented by Formula (F) in which the composition ratio is the composition ratio shown in FIG. 2, and the constituent proportions of the crystal phases are shown in FIG. 3. That is, powder a1′ is a powder of hydrogen-absorbing alloy (M).

### (1-d) Activation of Powder and Washing

The powder obtained in above (1-b) and an aqueous alkali solution (temperature: 100° C.) were mixed, and stirring was continued for 50 minutes to activate the alloy powder. As the aqueous alkali solution, an aqueous alkali solution having a potassium hydroxide concentration of 40 mass % was used. Next, the activated alloy powder was recovered, washed with warm water, and dehydrated. The washing was performed until the pH of the warm water after use reached less than or equal to 9. As a result, an alloy powder from which impurities were removed was obtained. In this manner, powder a1 of the hydrogen-absorbing alloy (hydrogen-absorbing alloy (M)) to be used for the negative electrode active material of battery A1 was obtained.

### (1-e) Measurement of Average Particle Size of Hydrogen-Absorbing Alloy Powder

The average particle size (D50) of obtained powder a1 was measured using a laser diffraction/scattering type particle size distribution measuring apparatus.

### (2) Production of Negative Electrode

First, a hydrogen-absorbing alloy was produced by the following procedure. Powder a1 of the hydrogen-absorbing alloy in an amount of 100 parts by mass, 0.2 parts by mass of carboxymethyl cellulose (thickener), 0.2 parts by mass of Ketjen black (conductive material), and 0.5 parts by mass of styrene-butadiene rubber (binder) were mixed to obtain a mixture. Water was added to the obtained mixture, and the mixture was further mixed to prepare a negative electrode paste.

Next, the negative electrode paste was applied to both surfaces of a negative electrode current collector to form a coating membrane. As the negative electrode current collector, punching metal made of iron plated with nickel was used. The obtained coating membrane was dried and then pressed together with the negative electrode current collector to form a negative electrode mixture layer. The negative electrode mixture layer was formed such that the entire negative electrode substantially has the same thickness. Next, a sheet including the negative electrode current collector and the negative electrode mixture layer was cut into a predetermined size to obtain a negative electrode.

### (3) Production of Positive Electrode

First, particles of nickel hydroxide and a predetermined amount of water were mixed to prepare a positive electrode paste. Next, the positive electrode paste was filled in a sheet of foamed nickel porous body (positive electrode current collector) and dried. The obtained sheet was compressed in a thickness direction and then cut into a predetermined size to produce a positive electrode.

### (4) Production of Alkaline Storage Battery

The produced positive electrode and negative electrode and a separator were wound to produce a wound body (electrode group). As the separator, a sulfonated polypropylene nonwoven fabric was used.

Next, the wound body and an alkaline electrolytic solution were housed in a battery case. As the alkaline electrolytic solution, an electrolytic solution having a concentration of alkali metal hydroxide of 7.5 mol/L was used. As the alkali metal hydroxide, KOH, NaOH, and LiOH were mixed at KOH: NaOH: LiOH=7.0:0.2:0.3 (molar ratio) and used. The potassium concentration in the alkaline electrolytic solution was 7.0 mol/L. The alkaline electrolytic solution was injected into the battery case so as to be 2.1 cc per 1 Ah of positive electrode capacitance.

Next, the opening of the battery case was sealed with a gasket and a sealing body. At this time, the foamed nickel porous body (positive electrode current collector) and the sealing body (positive electrode terminal) were electrically connected via a connection member. The negative electrode and the battery case (negative electrode terminal) were electrically connected via a connection member. In this manner, an alkaline storage battery (battery A1) was produced.

### Other Batteries

A plurality of alkaline storage batteries shown in FIG. 2 were produced in the same manner and conditions as in the production of battery A1 except that the powder (negative electrode active material) of the hydrogen-absorbing alloy was different. Powders of the hydrogen-absorbing alloy were produced by the same method and under the same conditions as the production method of powder a1 except that ingots were produced such that a to d and x to y in Formula (F) had the values shown in FIG. 2. The powders of the hydrogen-absorbing alloy was evaluated in the same manner as powder a1′ at the stage before activation.

Negative electrodes were produced in the same manner as in the production of the negative electrode of battery A1 except that the produced alloy powders were used as the negative electrode active material. Using the negative electrodes, other batteries (nickel-metal hydride storage batteries) were produced in the same manner as in the production method of battery A1.

In this manner, a plurality of AA size alkaline storage batteries (nickel-metal hydride storage batteries) having a theoretical capacity of 1200 mAh were produced. The produced batteries were activated by performing charge and discharge 10 times each in an atmosphere at 50° C., and then the following evaluation was performed.

### (1) High-Rate Discharge Test at Low Temperature (−10° C., 2 It (A))

A high-rate discharge test at a low temperature was performed by the following procedure. First, the battery was charged at a current value of 0.5 It (A) for 2 hours and 24 minutes in an atmosphere of 20° C. (charge control: −dV=5 mV). Next, the battery was left in an atmosphere at −10° C. for 3 hours. Next, the battery was discharged at a current value of 2 It (A) in an atmosphere of −10° C. until the battery voltage reached 0.8 V. The discharge time at this time was defined as a low-temperature discharge characteristic (minutes). The longer the discharge time of high-rate discharge at a low temperature is, the more excellent the high-rate discharge characteristic at a low temperature is. Here, It (A)=1200 mA (theoretical capacitance/h).

### (2) High-Rate Discharge Test at Cryogenic Temperature ( −30° C., 2 It (A))

A high-rate discharge test at a cryogenic temperature was performed by the following procedure. First, the battery was charged at a current value of 0.5 It (A) for 2 hours and 24 minutes in an atmosphere of 20° C. (charge control: −dV=5 mV). Next, the battery was left in an atmosphere at −30° C. for 3 hours. Next, the battery was discharged at a current value of 2 It (A) in an atmosphere of −30° C. until the battery voltage reached 0.8 V. The discharge time at this time was defined as a cryogenic-temperature discharge characteristic (minutes). The longer the discharge time of high-rate discharge at a cryogenic temperature is, the more excellent the high-rate discharge characteristic at a cryogenic temperature is.

### (3) Charge-Discharge Cycle Test at Normal Temperature

A charge-discharge cycle test at normal temperature (20° C.) was performed according to the following procedure. First, a charge-discharge cycle with the following charge step, resting step, and discharge step as one cycle was repeated.
Charge step: The battery is charged at a current value of 1 It (A) for 1 hour and 12 minutes in an atmosphere of 20° C. (charge control: −dV=5 mV).
Resting step: The battery is left in an atmosphere at 20° C. for 30 minutes.
Discharge step: The battery is discharged at a current value of 1 It (A) in an atmosphere of 20° C. until the battery voltage reaches 1.0 V. The discharge capacitance in the discharge step is measured.

Assuming that the initial discharge capacitance of the charge-discharge cycle test was 100%, the number of cycles capable of maintaining a discharge capacitance of more than or equal to 60% was defined as number of cycles N. The larger number of cycles N in the charge-discharge cycle test is, the more excellent the charge-discharge cycle characteristics are.

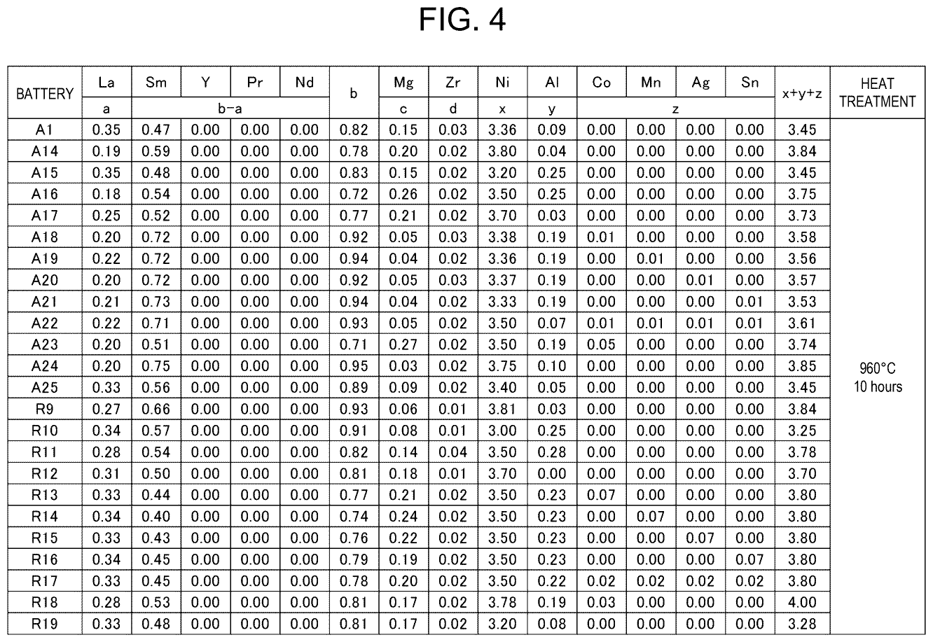

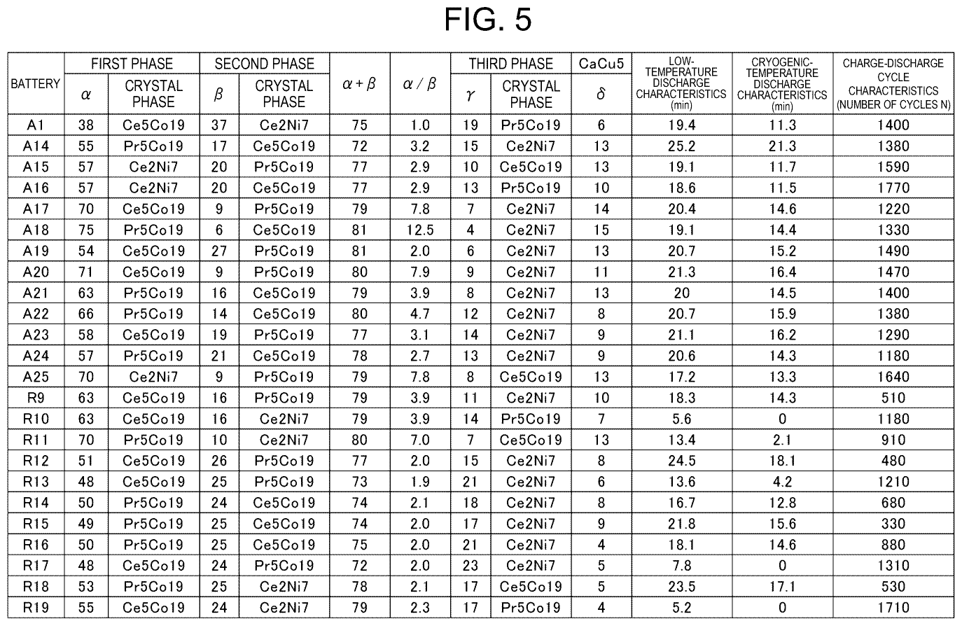

A part of the production conditions and the results of evaluation on the hydrogen-absorbing alloy used for the negative electrode of each battery, and the results of evaluation on the battery are shown in FIGS. 2 to 5. The results for battery A1 are also shown in FIGS. 4 and 5. In the following tables, the CaCu₅ type crystal phase, the Ce₂Ni₇ type crystal phase, the Ce₅Co₁₉ type crystal phase, and the Pr₅Co₁₉ type crystal phase may be denoted as CaCu5, Ce2Ni7, Ce5Co19, and Pr5Co19, respectively. In the following tables, the values in column (b-a) represent the composition ratios of Sm, Y, Pr, and Nd in Formula (F). For example, the composition of the hydrogen-absorbing alloy used in battery A7 is represented by a formula La_{0.08}Sm_{0.55}Pr_{0.10}Mg_{0.24}Zr_{0.03}Ni_{3.43}Al_{0.19}. Similarly, the value in column of z represents the composition ratio of Co, Mn, Ag, and Sn in Formula (F).

In the following tables, the low-temperature discharge characteristics and the cryogenic discharge characteristics are each preferably more than or equal to 10 minutes, and number of cycles N (charge-discharge cycle characteristics) is preferably more than or equal to 1000 cycles. The “0 minute” as the cryogenic-temperature discharge characteristics means that discharge at a cryogenic temperature was not possible (the same applies to the following tables).

Batteries A1 to A25 are alkaline storage batteries (A) using hydrogen-absorbing alloy (M). Batteries R1 to R19 are batteries of Comparative Examples. As shown in FIGS. 3 and 5, alkaline storage batteries (A) was excellent in both the cryogenic-temperature high-rate discharge characteristics and the charge-discharge cycle characteristics.

### Experimental Example 2

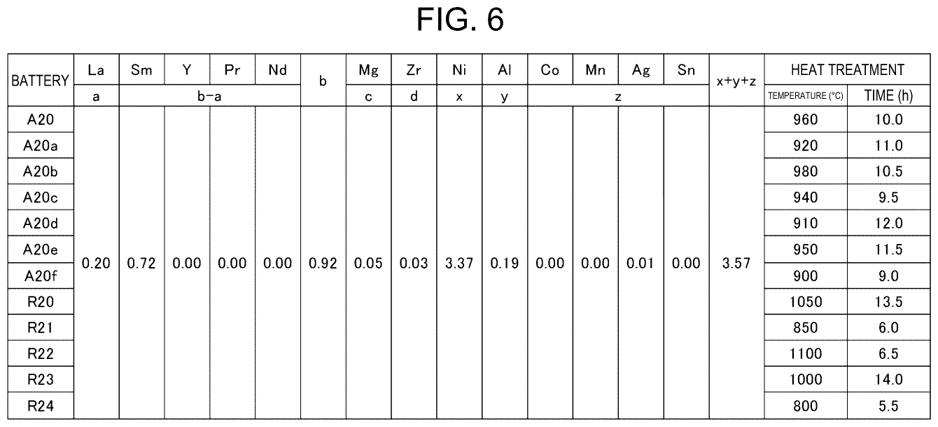

In Experimental Example 2, powders of a plurality of types of hydrogen-absorbing alloys were produced by the same method and under the same conditions as in the production of powder a1 of the hydrogen-absorbing alloy of Experimental Example 1 except that some conditions were changed. Specifically, the conditions for the heat treatment of the ingot were changed as shown in FIG. 6. In Experimental Example 2, the heat treatment of the ingot was performed under an argon atmosphere in the same manner as in the production of powder a1, and the temperature of the heat treatment and/or the time of the heat treatment were changed as shown in FIG. 6. The composition of the hydrogen-absorbing alloy was the same as the composition of the hydrogen-absorbing alloy used in battery A20. The powders of the hydrogen-absorbing alloys were evaluated in the same manner as in Experimental Example 1 at the stage before activation.

A plurality of batteries (nickel-metal hydride storage batteries) were produced in the same manner and under the same conditions as in the production of battery A1 except that the obtained powders of the hydrogen-absorbing alloys were used as the negative electrode active material. The obtained batteries were evaluated in the same manner as in Experimental Example 1.

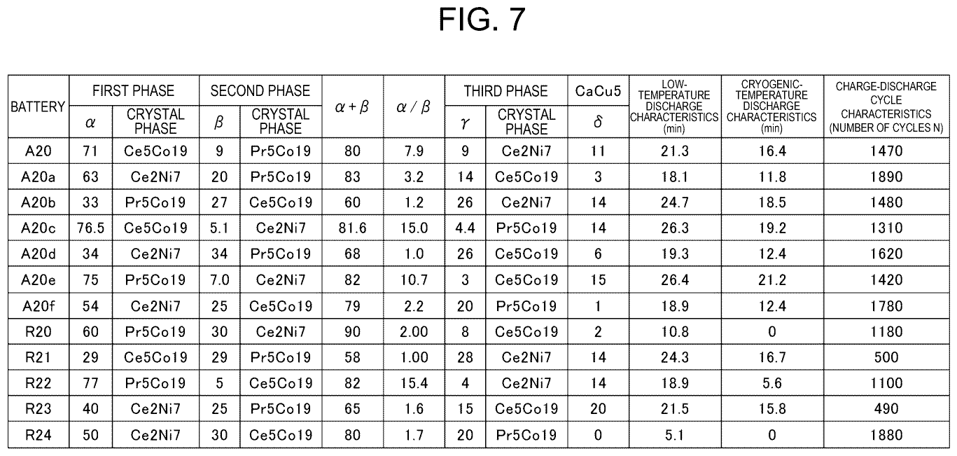

A part of the production conditions and the results of evaluation on the hydrogen-absorbing alloys, and the results of evaluation on the batteries are shown in FIGS. 6 and 7. The results for battery A20 are also shown in FIGS. 6 and 7.

Batteries A20 and A20a to A20f are alkaline storage batteries (A) using hydrogen-absorbing alloy (M). Batteries R20 to R24 are batteries of Comparative Examples. As shown in FIG. 7, alkaline storage batteries (A) was excellent in both the cryogenic-temperature high-rate discharge characteristics and the charge-discharge cycle characteristics.

### Experimental Example 3

In Experimental Example 3, a plurality of batteries (nickel-metal hydride storage batteries) were prepared by the following method.

### Batteries B1 to B4

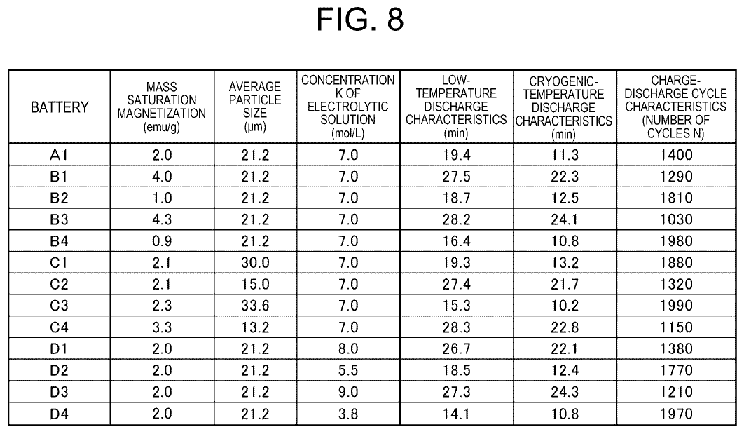

Powders of a plurality of types of hydrogen-absorbing alloys were produced by the same method and under the same conditions as in the production of powder a1 of the hydrogen-absorbing alloy of Experimental Example 1 except that the mass saturation magnetization of the hydrogen-absorbing alloy powder was changed as shown in FIG. 8. The mass saturation magnetization of the hydrogen-absorbing alloy powder was changed by treating the alloy powder with an aqueous alkali solution, and then subjecting the alloy powder to a treatment of adding an acidic aqueous solution and stirring. At that time, the magnetic susceptibility of the alloy powder was changed as shown in FIG. 8 by changing the stirring time. The composition of the alloy powders is the same as the composition of powder a1. Even when the mass saturation magnetization was changed, the constituent proportions of the crystal phases were almost the same as those of powder a1.

The average particle size (D50) of the obtained powder of the hydrogen-absorbing alloy was measured by the method described above. The mass saturation magnetization of the obtained powder of the hydrogen-absorbing alloy was measured by the method described above.

Batteries B1 to B4 (nickel-metal hydride storage batteries) were produced in the same manner and under the same conditions as in the production of battery A1 except that the obtained powders of the hydrogen-absorbing alloys were used as the negative electrode active material. The obtained batteries were evaluated in the same manner as in Experimental Example 1.

### Batteries C1 to C4

Powders of a plurality of types of hydrogen-absorbing alloys were produced by the same method and under the same conditions as in the production of powder a1 of the hydrogen-absorbing alloy of Experimental Example 1 except that the average particle size of the powder of the hydrogen-absorbing alloy was changed. The average particle size of the hydrogen-absorbing alloy powder was changed by changing the conditions of the pulverization step. The composition of the alloy powder was the same as the composition of powder a1. Even when the average particle size was changed, the constituent proportions of the crystal phases were almost the same as those of powder a1. The average particle size (D50) of the produced hydrogen-absorbing alloy was measured by the method described above. Further, the mass saturation magnetization of the obtained powder of the hydrogen-absorbing alloy was measured by the method described above. The mass saturation magnetization is changed not only by the treatment in an aqueous alkali solution but also by the average particle size.

Batteries C1 to C4 (nickel-metal hydride storage batteries) were produced in the same manner and under the same conditions as in the production of battery A1 except that the obtained powders of the hydrogen-absorbing alloys were used as the negative electrode active material. The obtained batteries were evaluated in the same manner as in Experimental Example 1.

### Batteries D1 to D4

Batteries D1 to D4 (nickel-metal hydride storage batteries) were produced in the same manner and under the same conditions as in the production of battery A1 except that the potassium concentration (K concentration) of the alkaline electrolytic solution was changed as shown in FIG. 8. The K concentration was changed by changing the amount of KOH dissolved in the alkaline electrolytic solution. As the negative electrode active material, powder a1 used for producing battery A1 was used. The obtained batteries were evaluated in the same manner as in Experimental Example 1.

A part of the results of evaluation on the hydrogen-absorbing alloy, the K concentration in the electrolytic solution, and the results of evaluation on the battery are shown in FIG. 8. The results for battery A1 are also shown in FIG. 8.

Batteries shown in FIG. 8 are alkaline storage batteries (A) using hydrogen-absorbing alloy (M). As is apparent from the comparison of batteries B1 to B4, by setting the mass saturation magnetization of the hydrogen-absorbing alloy to be the range from 1.0 emu/g to 4.0 emu/g, a battery particularly excellent in cryogenic-temperature high-rate discharge characteristics and charge-discharge cycle characteristics was obtained.

As is apparent from the comparison of batteries C1 to C4, by setting the average particle size of the hydrogen-absorbing alloy to be the range from 15 μm to 30 μm, a battery particularly excellent in cryogenic-temperature high-rate discharge characteristics and charge-discharge cycle characteristics was obtained.

As is apparent from the comparison of batteries D1 to D4, by setting the K concentration in the alkaline electrolytic solution in the range from 5.5 mol/L to 8.0 mol/L, a battery particularly excellent in cryogenic-temperature high-rate discharge characteristics and charge-discharge cycle characteristics was obtained.

### Experimental Example 4

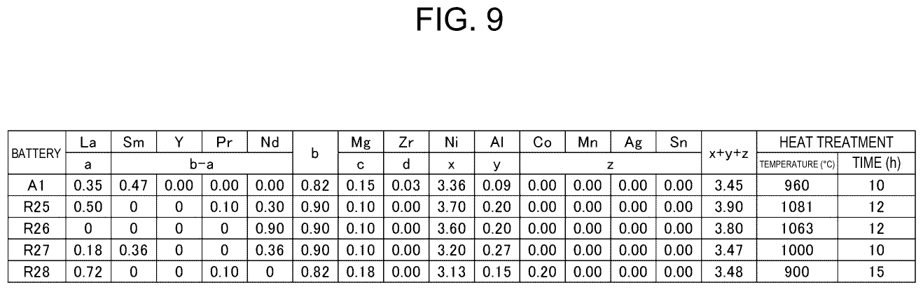

In Experimental Example 4, powders of a plurality of types of hydrogen-absorbing alloys were produced by the same method and under the same conditions as in the production of powder a1 of the hydrogen-absorbing alloy of Experimental Example 1 except that some conditions were changed. Specifically, the composition of the alloy and the conditions for the heat treatment of the ingot were changed as shown in FIG. 9 to produce powders of hydrogen-absorbing alloys. The powders of the hydrogen-absorbing alloys were evaluated in the same method as in Experimental Example 1 at the stage before activation.

Batteries R25 to R28 (nickel-metal hydride storage batteries) were produced in the same manner and under the same conditions as in the production of battery A1 except that the produced powders of the hydrogen-absorbing alloys were used as the negative electrode active material. The obtained batteries were evaluated in the same manner as in Experimental Example 1.

A part of the production conditions and the results of evaluation on the hydrogen-absorbing alloys, and the results of evaluation on the batteries are shown in FIG. 9. The results for battery A1 are also shown in FIG. 9.

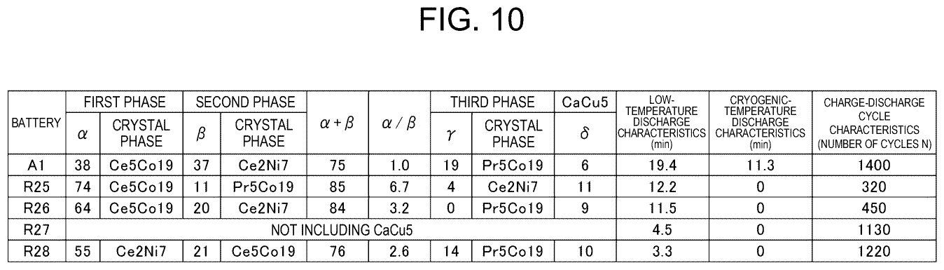

Batteries R25 to R28 are batteries of Comparative Examples. As shown in FIG. 10, the batteries of Comparative Examples had low cryogenic-temperature high-rate discharge characteristics and charge-discharge cycle characteristics.

### Experimental Example 5

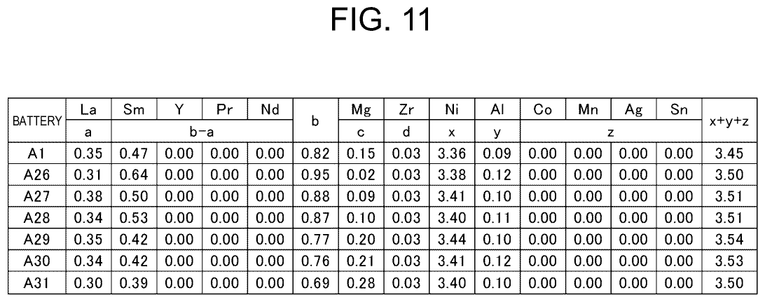

In Experimental Example 5, powders of a plurality of types of hydrogen-absorbing alloys were produced by the same method and under the same conditions as in the production of powder a1 of the hydrogen-absorbing alloy of Experimental Example 1 except that the content of Mg was changed. Specifically, hydrogen-absorbing alloys were produced so that the value of c in Formula (F) had the values shown in FIG. 11. The powders of the hydrogen-absorbing alloys were evaluated in the same manner as in Experimental Example 1 at the stage before activation.

A plurality of batteries (nickel-metal hydride storage batteries) were produced in the same manner and under the same conditions as in the production of battery A1 except that the obtained powders of the hydrogen-absorbing alloys were used as the negative electrode active material. The obtained batteries were evaluated in the same manner as in Experimental Example 1.

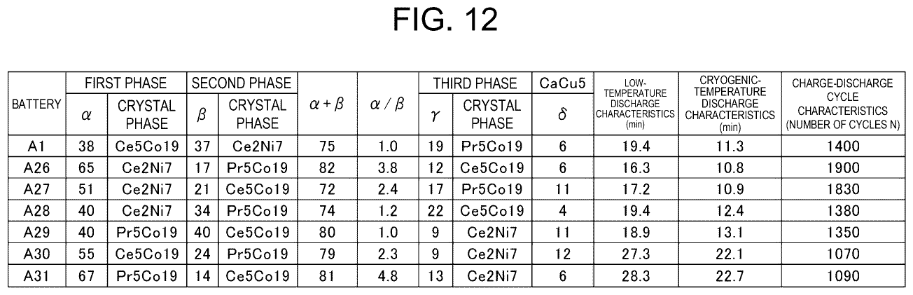

A part of the production conditions and the results of evaluation on the hydrogen-absorbing alloys, and the results of evaluation on the batteries are shown in FIGS. 11 and 12. The results for battery A1 are also shown in FIGS. 11 and 12.

Batteries A26 to A31 are alkaline storage batteries (A) using hydrogen-absorbing alloy (M). As shown in FIG. 12, batteries A26 and A27 in which the value of c was more than or equal to 0.01 and less than 0.10 (for example, in the range from 0.02 to 0.09) had particularly high charge-discharge cycle characteristics. Batteries A30 and A31 in which the value of c is more than 0.20 and less than or equal to 0.30 (for example, in the range from 0.21 to 0.28) had particularly high high-rate discharge characteristics at a low temperature and a cryogenic temperature.

### INDUSTRIAL APPLICABILITY

The present disclosure can be used for an alkaline storage battery (for example, a nickel-metal hydride storage battery).

### REFERENCE MARKS IN THE DRAWINGS

1 negative electrode
2 positive electrode
3 separator

14 battery case
7 sealing body
8 insulating gasket
9 positive electrode current collection plate
10 alkaline storage battery
11 alkaline electrolytic solution

1. A hydrogen-absorbing alloy having a composition represented by Formula (F) shown below: 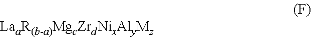
wherein R is at least one rare earth element including Y but not including La,
0.10≤a≤0.40, 0.67≤b≤0.96, 0.01≤c≤0.30, 0.01≤d≤0.05, and b+c+d=1.00 are satisfied,
M is at least one element selected from the group consisting of Co, Mn, Ag, and Sn,
3.10≤x≤3.80, 0.03≤y≤0.25, 0≤z≤0.05, and 3.45≤x+y+z≤3.85 are satisfied,
the hydrogen-absorbing alloy comprises, as crystal phases:
a first phase that is one phase selected from the phase group consisting of a phase having a Ce₂Ni₇ type structure, a phase having a Ce₅Co₁₉ type structure, and a phase having a Pr₅Co₁₉ type structure;
a second phase that is another phase selected from the phase group;
a third phase that is still another phase selected from the phase group; and
a fourth phase having a CaCu₅ type structure, and
in the crystal phases, δ<α,γ≤β≤α, 60≥α+β≤83, α/β≤15.0, and 1≤δ≤15 are satisfied, where a (mass %) is a constituent proportion of the first phase, β (mass %) is a constituent proportion of the second phase, γ (mass %) is a constituent proportion of the third phase, and 67 (mass %) is a constituent proportion of the fourth phase.

2. The hydrogen-absorbing alloy according to claim 1, wherein
0.01≤c≤0.10 is satisfied in Formula (F).

3. The hydrogen-absorbing alloy according to claim 1, wherein
0.20≤c≤0.30 is satisfied in Formula (F).

4. The hydrogen-absorbing alloy according to claim 1, wherein the hydrogen-absorbing alloy has an average particle size in a range from 15 μm to 30 μm.

5. An alkaline storage battery comprising:
a positive electrode,
a negative electrode containing a negative electrode active material, and
an alkaline electrolytic solution,
wherein
the negative electrode active material contains the hydrogen-absorbing alloy according to claim 1.

6. The alkaline storage battery according to claim 5, wherein
potassium hydroxide is dissolved in the alkaline electrolytic solution, and
the alkaline electrolyte solution has a potassium concentration in a range from 5.5 mol/L to 8.0 mol/L.

7. The alkaline storage battery according to claim 5, wherein
the hydrogen-absorbing alloy has a mass saturation magnetization in a range from 1.0 emu/g to 4.0 emu/g.
